(19) United States
(12) Patent Application Publication
(10) Pub. No.: US 2011/0197693 A1
(43) Pub. Date: Aug. 18, 2011

(54) SCREW-TYPE GEAR AND METHOD OF ITS MANUFACTURING

(76) Inventor: Evgeny Nikolaevich Zakharov, Moscovskaya oblast (RU)

(21) Appl. No.: 12/998,370

(22) PCT Filed: Oct. 13, 2009
(86) PCT No.: PCT/RU2009/000539

§ 371 Date: Apr. 13, 2011

(30) Foreign Application Priority Data
Oct. 14, 2008 (RU) 2008140444

(51) Int. Cl. F16H 25/22; B21D 53/28

(52) U.S. Cl. 74/424.89; 29/893

(57) ABSTRACT

The inventions relate to mechanical engineering, in particular to screw-type gears with rolling elements. The technical result of the proposed device and method consists in reducing the mass and overall dimensions of a gear and increasing the operational reliability and service life thereof. The essence of the invention is that one of the gear parts, either a screw or a nut, is made of two coaxial sections with curved end faces, and that a part of a rolling path is formed on each of the curved end faces. The coaxial sections are disposed so that the curved end faces thereof are arranged opposite one another with a clearance and the rolling elements are encompassed by both parts of the rolling path. The clearance in the gear is selected by pressing one coaxial section against the other in the axial direction. The method for producing the gear involves cutting either the screw or the nut into two coaxial sections along a curved trajectory that passes along the trajectory of the rolling path of the part to be cut. During assembly, the rolling elements are arranged along the cutting line between the sections of the cut part and the above-mentioned coaxial sections are tied along the axis of rotation of the screw or the nut with the aim of selecting the axial clearance in the screw-type gear.

### FIELD OF THE INVENTION

The inventions relate to the sphere of machine building, in particular to the screw-type gears with rolling elements.

### BACKGROUND ART

As is known there exists a screw-type gear with interference of rolling elements, containing a lead screw with a spiral race groove, two nuts with spiral race grooves, rolling elements fitted into the race grooves of the screw and nuts and capable of moving in the said race grooves, where the interface between the rolling elements and the surfaces of the screw and nut race grooves provides, at a minimum, for taking up the clearance by relative displacement of nuts to opposite directions relative to the screw (Ref. Parts of Aviation and Space Technology Mechanisms, under the editorship of Yu. M. Klimov, p. 179, Moscow, MAI, 1996).

The disadvantages of the known gear are its large longitudinal dimensions along the screw rotation axis, weight of the gear along with low reliability and short life.

### SUMMARY OF THE INVENTION

As regards both the design and method, the technical result of the claimed invention is decreased gear weight and dimensions along with increased reliability and life.

As regards the design, according to the invention the claimed objective may be achieved by making in the screw-type gear with interference of rolling elements, containing a lead screw with a spiral race groove, one nut with a spiral race groove, rolling elements fitted into the race grooves of the screw and nut and capable of moving in the said race grooves, where the interface between the rolling elements and the surfaces of the screw and nut race grooves provides, at a minimum, for taking up the clearance, one gear part, either the screw or the nut, of two co-axial pieces with curved end surfaces, each curved end surface accommodating a certain part of the race groove; the co-axial pieces are mounted so that their curved end surfaces face one another with a certain clearance and make it possible for the rolling elements to be enveloped by both parts of the race groove, while the gear clearance may be taken up by thrusting one co-axial piece against the other one in the axial direction.

As regards the design, the claimed objective may also be achieved by providing the co-axial pieces with a guiding element being common for the two pieces and arranged in parallel to the gear rotation axis.

As regards the method, according to the invention the claimed objective may be achieved by the fact that during manufacture of the screw-type gear with interference of rolling elements comprising a screw and a nut with spiral race grooves, either the screw or the nut is cut into two co-axial pieces according to a curved trajectory passing along the trajectory of the race groove in the part being cut, and the rolling elements are arranged along the cutting line between the pieces of the cut part and draw the said co-axial pieces together along the screw or nut rotation axis to take up the axial clearance in the screw-type gear.

As regards the method, the claimed objective may also be achieved by the fact that the co-axial pieces, while being drawn together, additionally take up the radial clearance in the screw-type gear.

As regards the method, the claimed objective may also be achieved by cutting the part after the spiral race groove is made therein, or at first by cutting the part, joining its pieces together in the desired position with a clearance provided between the curved end surfaces along the cutting line, and then making a spiral race groove in its surface.

As regards the method, the claimed objective may also be achieved by shaping guiding surfaces in the part, before cutting the latter, which will contact with the guiding element to be installed during the gear assembly.

### BRIEF DESCRIPTION OF THE DRAWINGS

FIG. 1 shows the longitudinal section of the screw-type gear;

FIG. 2 shows the version with an additional groove;

FIG. 3 shows the gear appearance.

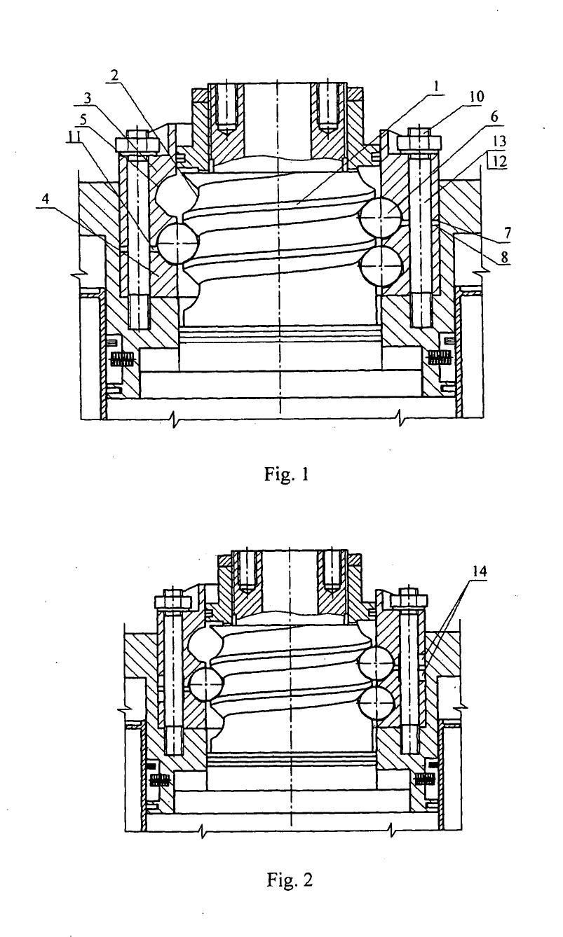

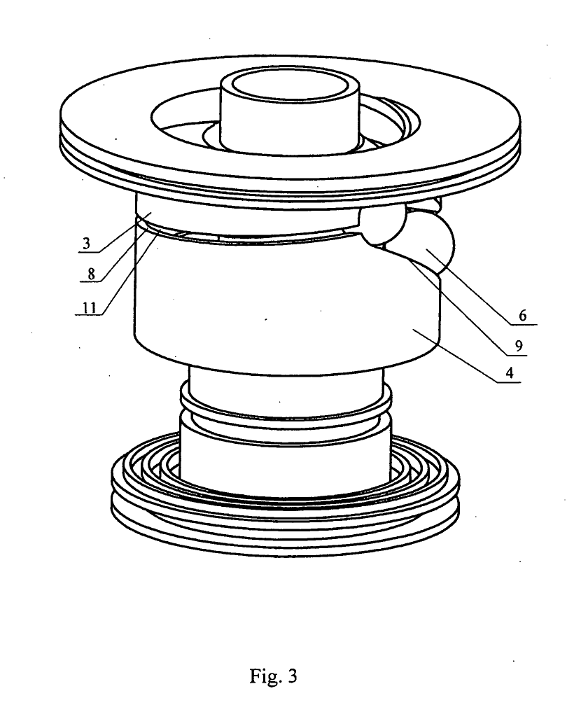

### THE BEST EMBODIMENT OF THE INVENTION

The described gear contains lead screw 1 with spiral race groove 2, two pieces 3 and 4 of the nut with spiral race groove 5 and rolling elements 6 fitted into grooves 2 and 5. End surfaces 7 and 8 of pieces 3 and 4, respectively, are made according to a curved, for example spiral, trajectory. Thereat, one part of spiral groove 5 is made on end surface 9 and the other part of groove 5 is made on end surface 8. By-pass groove 9 which connect the beginning and end of race grooves 2 and 5 is made, for example, in the nut body. During assembly, rolling elements 6 are fitted along race groove 2 of screw 1 and into by-pass groove 9. Then both pieces 3 and 4 of the nut are brought from both sides to rolling elements 6 and are drawn together by means of threaded joints 10, which may act as guiding surfaces preventing piece 3 from turning relative to piece 4. While pieces 3 and 4 are drawn together, the slant surfaces, when rolling elements 6 are made as balls, force them towards race groove 2. Thus, not only the axial interference is created, but the radial one as well.

When groove 2 is made as two slant surfaces, a four-point contact in the screw-type gear is provided. In this case screw 1 is centered relative to the nut along the surfaces of rolling elements 6, thereat one loop of race grooves 2 and 5 is enough to provide stable relative position of the nut and screw 1.

Pieces 3 and 4 of the nut are made by cutting it according to a curved trajectory, along which clearance 11 is created after pieces 3 and 4 are joined together. To make cutting easier, wider preliminary groove 14 is made which is shown in FIG. 2. The nut may be cut after making spiral groove 5. The nut blank may be cut in advance and then pieces 3 and 4 may be joined together by means of temporary ties (not shown in diagrams) with clearance 11 ensured, whereupon spiral race groove may be made along clearance 11 trajectory. Prior to cutting the nut into pieces 3 and 4 it is desirable to form guiding surfaces in yet integral part, for example, by drilling hole 12 along the nut rotation axis. In this case, when assembling the gear, pieces 3 and 4 will occupy the proper position when guiding elements 13 are fitted into holes 12. Elements 13 will provide stiffness of the assembled part and may also be used for tying up the joint.

### INDUSTRIAL APPLICABILITY

Thus the claimed inventions make it possible to ensure minimum dimensions and weight of the screw-type gear with rolling elements due to exclusion of the second nut from one gear. Therewith, the assembly operation is ensured with half as many rolling elements (in known gears the first nut assembly transfers load in one direction, while the second nut assembly in the other direction). Fewer elements provide for considerable reduction of friction losses in the gear, increased reliability and life.

1. A screw-type gear with interference of rolling elements, comprising a lead screw with a spiral race groove, one nut with a spiral race groove, rolling elements fitted into the race grooves of the screw and nut and capable of moving in the said race grooves where the interface between the rolling elements and the surfaces of the screw and nut race grooves provides, at a minimum, for taking up the clearance, characterized in that one gear part—either the screw or the nut—is made of two co-axial pieces with curved end surfaces, each curved end surface accommodating a certain part of the race groove; the co-axial pieces are mounted so that their curved end surfaces face one another with a certain clearance and make it possible for the rolling elements to be enveloped by both parts of the race groove, while the gear clearance may be taken up by thrusting one co-axial piece against the other one in the axial direction.

2. A gear of claim 1, wherein the co-axial pieces with curved end surfaces are provided with a common guiding element arranged in parallel to the gear rotation axis.

3. A manufacturing method of the screw-type gear with interference of rolling elements comprising a screw and a nut with spiral race groove consisting in that either the screw or the nut is cut into two co-axial pieces according to a curved trajectory passing along the trajectory of the race groove in the part being cut, and the rolling elements are arranged along the cutting line between the pieces of the cut part and draw the said co-axial pieces together along the screw or nut rotation axis to take up, at a minimum, the axial clearance in the screw-type gear.

4. A method of claim 3, wherein the co-axial pieces, while being drawn together, additionally take up the radial clearance in the screw-type gear.

5. A method of claim 3, wherein the part is cut after the spiral race groove is made therein.

6. A method of claim 3, wherein the part is cut, its pieces are joined together in the desired position with a clearance provided between the curved end surfaces along the cutting line, and then a spiral race groove is made in its surface.

7. A method of claim 3, wherein prior to cutting the part guiding surfaces are formed therein, which will contact with the guiding element to be installed during the gear assembly.
